(19) United States
(12) Patent Application Publication
(10) Pub. No.: US 2022/0401200 A1
(43) Pub. Date: Dec. 22, 2022

(54) Electric Toothbrush Base Protector

(71) Applicant: Davor Hrboka, Ashtabula, OH (US)

(72) Inventor: Davor Hrboka, Ashtabula, OH (US)

(21) Appl. No.: 17/480,782

(22) Filed: Sep. 21, 2021

Related U.S. Application Data
(60) Provisional application No. 63/211,456, filed on Jun. 16, 2021.

(51) Int. Cl. A61C 17/22; A46B 17/08

(52) U.S. Cl. CPC A61C 17/224; A46B 17/08

(57) ABSTRACT

The present invention relates to an electric toothbrush base protector. The protector is in the form of a cover or liner that can be placed on a sink on top of a toothbrush charging unit. The cover eliminates contact of a base of the electric toothbrush with the sink surface and with the top of the charging unit. The material of the cover can be a plastic, a cotton or other material. The cover features a continuous opening that enables the electric toothbrush to be placed on the top surface of the charging base. The cover prevents contamination and enables users to quickly secure and store the toothbrush immediately after use.

### CROSS-REFERENCE TO RELATED APPLICATION

The present application claims priority to, and the benefit of, U.S. Provisional Application No. 63/211,456, which was filed on Jun. 16, 2021 and is incorporated herein by reference in its entirety.

### FIELD OF THE INVENTION

The present invention relates generally to the field of electric toothbrushes. More specifically, the present invention relates to a safety cover or liner for an electric toothbrush base. The safety cover or liner is placed on top/charging surface of an electric toothbrush charger for acting as a barrier between the charger and base of the electric toothbrush. The cover can include designs and prints to match the toothbrush and can have an antimicrobial layer. A continuous hole or cutout in the cover or space can be used for receiving and circumscribing the charging pin(s) of the charger. The cover can be placed on the top of a charger surface to eliminate contact of the base of the toothbrush with the sink surface. Accordingly, the present disclosure makes specific reference thereto. Nonetheless, it is to be appreciated that aspects of the present invention are also equally applicable to other like applications, devices and methods of manufacture.

### BACKGROUND

Everyone is aware that brushing teeth is necessary for adding to the health and longevity of the teeth, and also necessary for a pleasant appearance, oral health and pleasant smelling breath. In fact, dentists recommend that one's teeth be brushed once in the morning, after every meal and once prior to retiring to bed at night. Typical electric toothbrushes comprise a handle section accommodating a motor, a power source and a switch to control the motor. The electric toothbrushes are recharged using a charging unit that is portable and is generally kept on a bathroom sink. Users also generally keep the electric toothbrushes directly on the sink in an upright position, mounted on the charger.

However, bacteria such as Streptococcus, Campylobacter and Escherichia coli (E. coli) are present in the bathroom, and specifically near the sink area where the users generally keep their toothbrushes and electric toothbrush chargers. These bacteria can cause painful symptoms such as stomach cramps, nausea, diarrhea and vomiting. Further, the used toothbrush and the toothbrush chargers also attract bacteria, as the bacteria thrive more in damp areas. Therefore, damp toothbrushes and chargers are a source of bacteria and other pathogens which can accumulate on the toothbrush and potentially spread to the mouth area of the user.

Currently available devices and solutions cover and protect the bristles of the toothbrush from pathogens, but no device is available that protects the handle, base and other portions of the toothbrush from the pathogens. These pathogens can then reach the mouth from subsequent use of the components.

Specifically, for electric toothbrushes the chargers are a great source of contamination, as the charging surface can be contaminated with bacteria. The chargers are generally not washed, and the bacteria and other pathogens keep accumulating and are transferred to the toothbrush when the toothbrush is charged using the charger.

Therefore, there exists a long felt need in the art for a toothbrush safety device that ensures that the base of the toothbrush remains clean and contaminate free. There is also a long felt need in the art for a toothbrush safety device that provides safe storage of the electric toothbrush and the charger unit. Additionally, there is a long felt need in the art for a toothbrush safety device that eliminates transmission of pathogens from the charger unit to the electric toothbrush. Moreover, there is a long felt need in the art for a toothbrush safety device that is cost-effective and disposable. Further, there is a long felt need in the art for a toothbrush safety device that can be used with any conventional electric toothbrush and charger unit. Furthermore, there is a long felt need in the art for a toothbrush safety device that eliminates contact of a toothbrush with the sink area. Finally, there is a long felt need in the art for a toothbrush safety device that enables a user to quickly secure and store the toothbrush immediately after use.

The subject matter disclosed and claimed herein, in one embodiment thereof, comprises a liner or protective cover for a base of an electric toothbrush to prevent the toothbrush from contamination. The liner or protective cover is disposable, and is designed to be placed on the top of a charging surface of the electric toothbrush charger or on a sink surface, and acts as a protective barrier for the base of the electric toothbrush. More specifically, the toothbrush charger base liner comprises a single-unit disposable cover made up of a soft material and includes a top surface, a bottom surface and at least one continuous hole or cut-out for receiving and circumscribing a charging pin(s) of the charger. The cover can be placed on the charging surface of the charger with the bottom surface touching the charging surface of the charger and the top surface touching the base of an electric toothbrush, placed on the charger for charging or secure storage. The continuous cut-out opening enables the charging pin to insert into the charging slot disposed in the base of the electric toothbrush. Thus, the cover prevents the base of the toothbrush from touching the charging surface of the charger.

In this manner, the novel safety cover or liner for electric toothbrush chargers and holders accomplishes all of the forgoing objectives, and provides a relatively safe, cost-effective, easy to use, and disposable device to ensure that the base of the toothbrush remains clean and contaminate free. The cover prevents contamination by eliminating contact of the toothbrush base with the sink surface and with the top surface of a charger. The cover is disposable and enables a user to quickly secure and store the toothbrush immediately after use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a disposable cover or liner for protecting a base of an electric toothbrush from contamination. The disposable cover or liner is designed to be placed on a top charging surface of the electric toothbrush charger, and acts as a protective barrier for the base of the electric toothbrush. More specifically, the disposable cover or liner comprises a single-unit disposable cover or liner made up of a soft material and includes a top surface, a bottom surface and at least one continuous hole or cut-out for receiving and circumscribing a charging pin(s) of the charger. The cover is placed on the charging surface of the charger with the bottom surface touching the charging surface of the charger, and the top surface touching the base of an electric toothbrush placed on the charger for charging or secure storage. The continuous cut-out hole or opening enables the charging pin to insert into the charging slot disposed in the base of the electric toothbrush. Thus, the cover prevents the base of the toothbrush from touching the charging surface of the charger.

In yet another embodiment, the disposable cover or liner includes a layer or coating of antimicrobial agent to kill microbes, and can include a logo or a trademark on the top surface for advertising and branding purposes.

In yet another embodiment, the cover is made up of one or more of cotton, nylon, or any other similar material, and preferably made up of triclosan and silver-based finished cotton including antimicrobial properties.

In yet another embodiment of the present invention, an electric toothbrush kit is disclosed. The kit includes an electric toothbrush, a charging unit and one or more disposable covers or liners for protecting the base of the electric toothbrush from pathogens. The disposable cover or liner is configured to be placed on top of the charging unit before placing the electric toothbrush thereon, and thus acts as a barrier to eliminate contact between the base of the electric toothbrush and the top of the charging unit.

In yet another embodiment of the present invention, the kit can include a package of disposable covers or liners having a quantity from about six to about twelve disposable covers or liners.

In yet another embodiment of the present invention, a method for protecting a base from an electric toothbrush from pathogens is described. The method includes placing a disposable cover or liner on a sink surface, then placing the base of the electric toothbrush on the cover in an upright manner to eliminate contact of the base with the sink surface.

In yet another embodiment of the present invention, another method for protecting a base from an electric toothbrush from pathogens is described. The method includes selecting a liner or cover based on the dimensions and design of an electric toothbrush charger, then sliding the hole or cut-out of the cover over the charging pin(s) of the charger and placing the cover on the charging surface, thereafter placing the electric toothbrush on the cover such that the charging pin of the cover is inserted into the charging slot at the base of the toothbrush, wherein the cover acts a barrier between the charger and the base of the electric toothbrush.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an electric toothbrush base protector of the present invention for an electric toothbrush charger in accordance with the disclosed architecture;

FIG. 2 illustrates a perspective view of an exemplary electric toothbrush kit of the present invention that includes an electric toothbrush, a charging unit and an electric toothbrush base protector in accordance with the disclosed architecture;

FIG. 3 illustrates a perspective view showing how one potential embodiment of the electric toothbrush base protector cover can be placed on an electric toothbrush charger in accordance with the disclosed architecture;

FIG. 4 illustrates a perspective showing one potential embodiment of the disposable liner/cover of the present invention placed on the charging surface of the electric toothbrush charger and protecting the electric toothbrush in accordance with the disclosed architecture;

FIG. 5 illustrates a flow diagram showing steps performed by a user for installing one potential embodiment of the disposable liner of the present invention on the electric toothbrush charger/holder in accordance with the disclosed architecture; and

FIG. 6 illustrates a perspective view showing alternative embodiments of the disposable liner for electric toothbrush chargers of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a toothbrush safety device that ensures that the base of the toothbrush remains clean and contaminate free. There is also a long felt need in the art for a toothbrush safety device that provides safe storage of the electric toothbrush and the charger unit. Additionally, there is a long felt need in the art for a toothbrush safety device that eliminates the transmission of pathogens from the charger unit to the electric toothbrush. Moreover, there is a long felt need in the art for a toothbrush safety device that is cost-effective and disposable. Further, there is a long felt need in the art for a toothbrush safety device that can be used with conventional electric toothbrushes and charger units. Furthermore, there is a long felt need in the art for a toothbrush safety device that eliminates contact of a toothbrush with the sink surface area. Finally, there is a long felt need in the art for a toothbrush safety device that enables a user to quickly secure and store the toothbrush immediately after use.

The present invention, in one exemplary embodiment, includes a novel disposable cover or liner for protecting a base of an electric toothbrush from contamination. The disposable cover or liner is designed to be placed on a top charging surface of the electric toothbrush charger and acts a protective barrier for the base of the electric toothbrush. More specifically, the disposable cover or liner comprises a soft material and includes a top surface, a bottom surface and at least one continuous hole or cut-out for receiving and circumscribing a charging pin of the charger. In use, the cover is placed on the charging surface of the charger, with the bottom surface touching the charging surface of the charger and the top surface touching the base of an electric toothbrush placed on the charger for charging or secure storage. The continuous cut-out opening of the cover enables the charging pin(s) to be inserted, at least partially, into the charging slot disposed in the base of the electric toothbrush. In this way, the protective cover prevents the base of the toothbrush from touching the charging surface of the charger, and prevents the toothbrush from being contaminated with germs, etc.

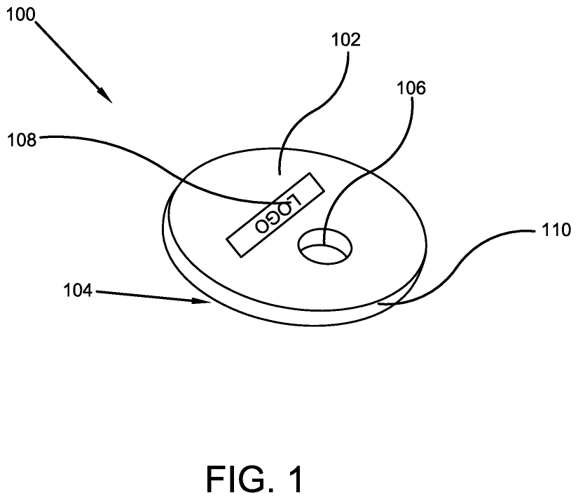

Referring initially to the drawings, FIG. 1 illustrates a perspective view of one potential embodiment of an electric toothbrush base protector of the present invention for an electric toothbrush charger in accordance with the disclosed architecture. The electric toothbrush base protector 100 includes a disposable cover or liner in the form of an electric toothbrush charger cover, that is specifically placed on a top surface of a charger, such that it acts as a barrier between the top surface of the charger and the bottom surface of the electric toothbrush. More specifically, the disposable liner or cover 100 comprises a thin layer of soft material such as plastic, cotton, fabric or the like. The cover 100 of the present embodiment can be substantially circular and includes a top surface 102 and a bottom surface 104. The top surface 102 can have a printed design or other logo 108 for marketing and advertising purposes. The bottom surface 104 can adhere to the electric toothbrush charger and thus, the cover 100 can be placed between the top of the charger and the base of the electric toothbrush. As per the design and the position of the charging pin(s) of the toothbrush charger, the cover 100 includes a hole or cut-out 106 along the height of the cover 100. The hole or cut-out 106 of the cover 100 slides over the charging pin(s) of the charger when the cover 100 is placed on the top of the charging unit. The hole or cut-out 106 enables the charging of the electric toothbrush, while the cover 100 protects the base of the toothbrush from microbes on the charging unit.

The cover 100 can include a thickness 110 in the range from about 0.25 cm to about 1.00 cm. The diameter of the cover 100 can be configured to fit and cover the top surface of the conventionally available electric toothbrush chargers. Further, the cover 100 can come in multiple colors and designs. The cover 100 can be coated with a layer of antimicrobial agent to kill any germs that may stick to it. The cover 100 can be disposable and can be replaced after a certain duration such as a week, in order to reduce toothpaste residue that runs down the handle of the electric toothbrush and settles on the cover 100.

The cover 100 can also be used for placing the electric toothbrush or any conventional toothbrush on a sink surface. The cover 100 provides a stable and safe standing platform for the users to place an electric toothbrush.

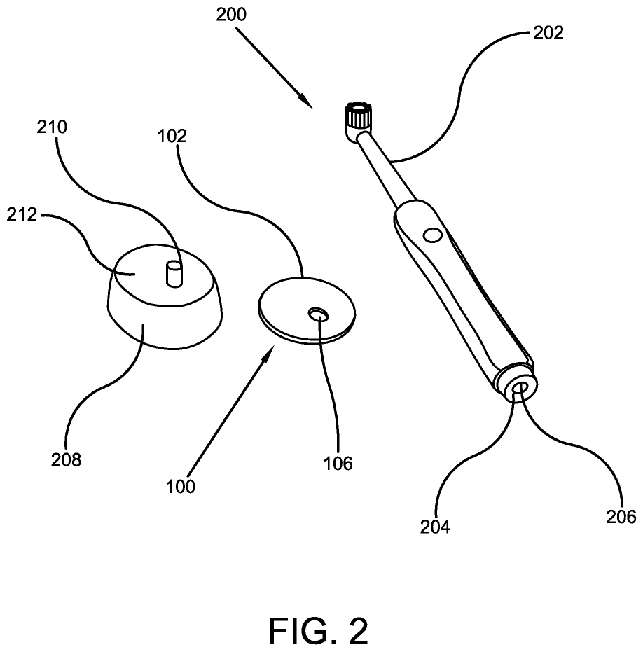

FIG. 2 illustrates a perspective view of an exemplary electric toothbrush kit of the present invention that includes an electric toothbrush, a charging unit and an electric toothbrush base protector in accordance with the disclosed architecture. In the present embodiment, an electric toothbrush kit 200 is shown. The electric toothbrush kit 200 can be commercially available with a single or a package of multiple disposable liners/covers 100 along with an electric toothbrush 202 and a toothbrush charging unit 208. The electric toothbrush base protector 100 can be designed and configured to be placed on a charging surface 212 of the charging unit 208 with the hole or cutout 106 circumscribing the charging pin(s) 210. The cover 100 prevents direct contact between the base 204 of the electric toothbrush 202 and the charging surface 212 of the charging unit 208. The charging slot 206 of the toothbrush 202 couples with the charging pin 210 while the cover 100 is placed on the charging surface 212, thereby allowing easy and smooth charging of the toothbrush 202 while protecting the base 204 of the toothbrush 202 from germs and microbes. The electric toothbrush base protector 100 can have the same design and color as of the toothbrush 202, in addition to the printed trademark of the brand of the toothbrush 202.

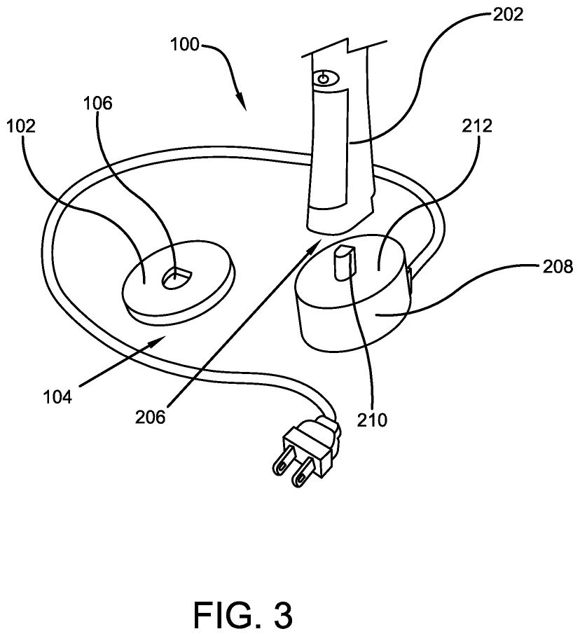

FIG. 3 illustrates a perspective view showing how the electric toothbrush base protector cover 100 is placed on an electric toothbrush charger 208 in accordance with the disclosed architecture. As shown here, the disposable cover or liner 100 is placed on the charging surface 212 of the charging unit 208, such that the bottom surface 104 touches the charging surface 212 and the top surface 102 faces away from the charging surface 212. The cut-out opening 106 can be dimensioned in accordance with the charging pin 210, and can be slid over the charging pin 210 for a secure placement of the cover 100 thereon. The hole or cut-out 106 is advantageous in that the cover 100 is not easily displaced, and is secured laterally on the charging surface 212, while also not impeding the charging functionality of the charging unit 208 as the charging pin 210 can be easily coupled with the charging slot 206 of the electric toothbrush 202. It should be appreciated that the thickness of the cover 100 can be slightly less than the height of the charging pin 210, thereby allowing a secure connection between the charging pin 210 and the charging slot 206.

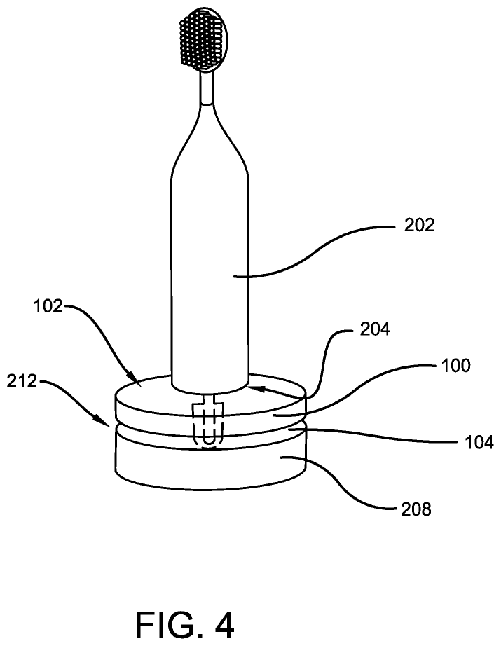

FIG. 4 illustrates a perspective showing the disposable liner/cover 100 of the present invention placed on the charging surface 212 of the electric toothbrush charger 208, and protecting electric toothbrush 202 in accordance with the disclosed architecture. As shown, the cover or liner 100 acts as a protective barrier preventing direct contact between the base 204 of the toothbrush 202 and the charging surface 212 of the charger 208. Specifically, the base 204 touches the top surface 102 of the cover 100 and the charging surface 212 touches the bottom surface 104 of the cover 100. The damp toothbrush base 204, after use of the toothbrush, remains in touch with the clean and safe cover 100, and thereby prohibits the accumulation of germs on the toothbrush 202 and maintains a safe hygienic oral instrument for the users. It should be appreciated that the cover 100 can be used for placing the electric toothbrush 202 upright on a sink with the cover 100 placed on the sink and acting as a barrier between the sink and the toothbrush.

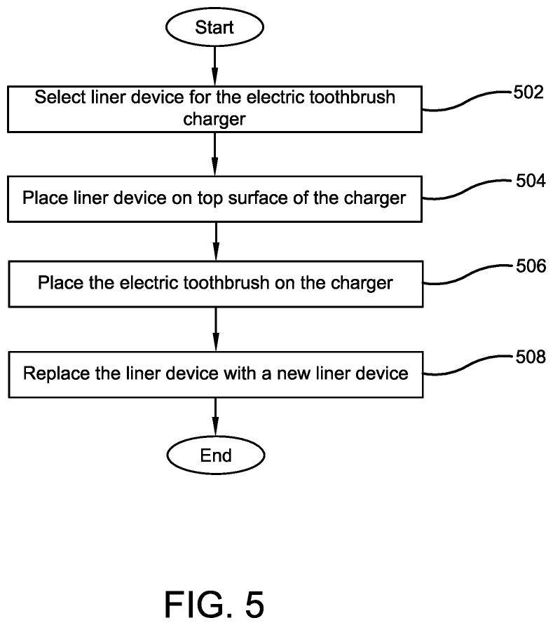

FIG. 5 illustrates a flow diagram showing steps performed by a user for installing the disposable liner or cover of the present invention on the electric toothbrush charger/holder in accordance with the disclosed architecture. Initially, a user selects a liner or cover based on the dimensions and design of the electric toothbrush charger (Block 502). Then, the hole or cut-out of the cover is slid over the charging pin(s) of the charger and the cover is placed on the charging surface (Block 504). Thereafter, after using the electric toothbrush, and for securely storing and placing the toothbrush, the electric toothbrush can be placed on the cover, such that the charging pin(s) of the charger is inserted into charging slot at the base of the toothbrush (Block 506). Finally, as per the requirement and desire of the user, the cover can be periodically replaced with a new cover to maintain the safety and hygiene of the base of the toothbrush (Block 508).

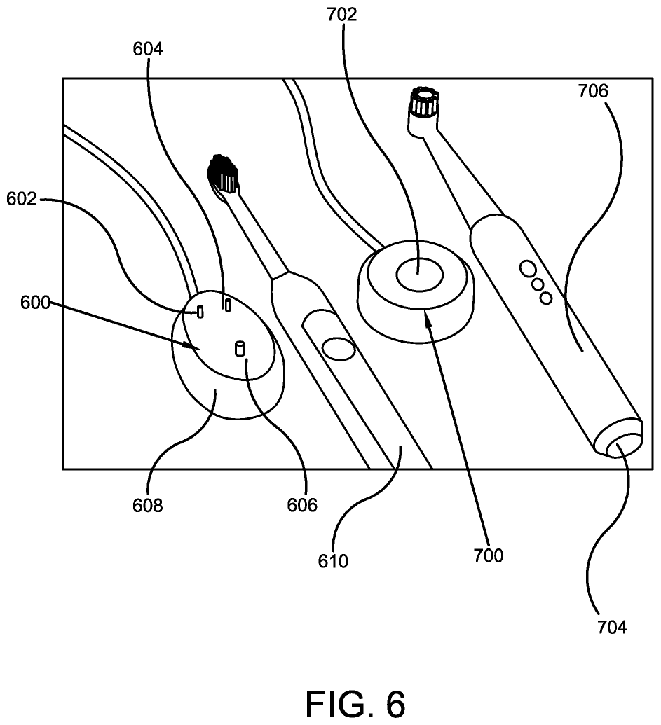

FIG. 6 illustrates a perspective view showing alternative embodiments of the disposable liner for electric toothbrush chargers in accordance with the disclosed architecture. As described supra, the disposable liner of the present invention comes in various variants to fit and place on currently available electric toothbrush chargers, and also can be customized easily based on the envisioned designs of the toothbrush chargers. As shown, the disposable liner 600 includes three hole or cut-outs 602, 604, 606 to receive the charging pins of the charger 608 and not only protects the base of the toothbrush 610 from contamination but also enables seamless charging of the toothbrush 610. Similarly, another variant of the electric toothbrush charger cover 700 includes a central cut-out hole 702 that receives the base 704 of the second toothbrush 706.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electric toothbrush base protector”, “disposable cover for electric toothbrush base protector”, “electric toothbrush charger cover”, “disposable cover or liner”, “disposable fabric” and “cover” are interchangeable and refer to the disposable cover for electric toothbrush base protector 100, 600, 700 of the present invention.

Notwithstanding the forgoing, the disposable cover for electric toothbrush base protector 100, 600, 700 of the present invention can be of any suitable size and configuration as is known in the art without affecting the overall concept of the invention, provided that it accomplishes the above-stated objectives. One of ordinary skill in the art will appreciate that the size, configuration, and material of the disposable cover for electric toothbrush base protector 100, 600, 700 as shown in the FIGS. are for illustrative purposes only, and that many other sizes and shapes of the disposable cover for electric toothbrush base protector 100, 600, 700 are well within the scope of the present disclosure. Although the dimensions of the disposable cover for the electric toothbrush base protector 100, 600, 700 are important design parameters for user convenience, the disposable cover for electric toothbrush base protector 100, 600, 700 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electric toothbrush base protector comprising:
a disposable cover for placement over a top surface of a toothbrush charger;
said disposable cover includes a cutout for receiving a charging pin of the toothbrush charger therethrough;
said disposable cover is positioned between said top surface of said toothbrush charger and a base of said electric toothbrush;
said disposable cover includes a material selected from the group consisting of a plastic, a cotton and a fabric; and
said disposable cover includes a thickness generally from about 0.25 cm to about 1.00 cm for enabling the charging of said electric toothbrush while said disposable cover provides a barrier between said base of said electric toothbrush and said top surface of said toothbrush charger.

2. The electric toothbrush base protector of claim 1, wherein said disposable cover is coated with an antimicrobial agent.

3. The electric toothbrush base protector of claim 2, wherein said disposable cover is generally circular in shape.

4. The electric toothbrush base protector of claim 3 further comprising a package of said disposable covers, wherein said package of said disposable covers comprises a plurality of between six and twelve of said disposable covers.

5. The electric toothbrush base protector of claim 1, wherein said cutout circumscribes said charging pin of said toothbrush charger.

6. The electric toothbrush base protector of claim 1, wherein said disposable cover comprises an antimicrobial agent layer.

7. An electric toothbrush base protector comprising:
a cover for placement over a top surface of a toothbrush charger;
said cover includes a cutout for receiving a charging pin of the charger therethrough;
said cutout circumscribes said charging pin of said toothbrush charger;
said cover is positioned between said top surface of said toothbrush charger and a base of said electric toothbrush;
said cover is coated with an antimicrobial agent; and
said cover includes a thickness generally from about 0.25 cm to about 1.00 cm for enabling the charging of said electric toothbrush while said cover provides a barrier between said base of said electric toothbrush and said top surface of said toothbrush charger.

8. The electric toothbrush base protector of claim 7, wherein said cover is generally circular in shape.

9. The electric toothbrush base protector of claim 8 further comprising a package of said covers, wherein said package includes a plurality of between six and twelve of said covers.

10. The electric toothbrush base protector of claim 9, wherein said cover comprises a material selected from a group consisting of a plastic, a cotton and a fabric.

11. The electric toothbrush base protector of claim 10, wherein said coating of said antimicrobial agent includes at least one layer of said antimicrobial agent.

12. An electric toothbrush kit comprising:
an electric toothbrush;
a charging unit; and
a package of a multiple of electric toothbrush base protectors;
wherein said electric toothbrush base protectors are disposable and are a liner for placement of said liner over a top surface of said charging unit;
wherein said liner comprises a cutout for receiving a charging pin of said charging unit therethrough;
wherein said cutout circumscribes said charging pin of said charging unit;
wherein said liner is positioned between said top surface of said charging unit and a base of said electric toothbrush; and
further wherein said liner includes a thickness generally from about 0.25 cm to about 1.00 cm for enabling the charging of said electric toothbrush while said liner provides a barrier between said base of said electric toothbrush and said top surface of said charging unit.

13. The electric toothbrush kit of claim 12, wherein said liner is generally circular in shape.

14. The electric toothbrush kit of claim 13, wherein said package of said base protectors comprises a plurality of between six and twelve said liners.

15. The electric toothbrush kit of claim 14, wherein said liner is coated with an antimicrobial agent.

16. The electric toothbrush kit of claim 15, wherein said coating of said antimicrobial agent includes at least one layer of said antimicrobial agent.

17. The electric toothbrush kit of claim 16, wherein said liner is comprised of a plastic.

18. The electric toothbrush kit of claim 16, wherein said liner is comprised of a cotton.

19. The electric toothbrush kit of claim 16, wherein said liner is comprised of a fabric.

20. The electric toothbrush kit of claim 16, wherein the thickness of the liner is less than a height of the charging pin.
